(19) United States
(12) Patent Application Publication
(10) Pub. No.: US 2009/0321601 A1
(43) Pub. Date: Dec. 31, 2009

(54) DEVICE FOR CONNECTING A PLURALITY OF WASTE RECEPTACLES

(76) Inventor: Stephen Kelly, San Jose, CA (US)

Correspondence Address: MURABITO, HAO & BARNES, LLP, TWO NORTH MARKET STREET, THIRD FLOOR, SAN JOSE, CA, 95113, US

(21) Appl. No.: 12/165,314

(22) Filed: Jun. 30, 2008

(51) Int. Cl. F16B 45/00; B23P 19/04; B65D 21/02

(52) U.S. Cl. 248/304; 29/700; 220/23.86

(57) ABSTRACT

Embodiments of the claimed subject matter provide a device and method for transporting a plurality of waste receptacles. One embodiment of the claimed subject matter is a device for transporting a plurality of coupled waste receptacles. The device comprises a plurality of securing ends, which may include a latch portion for coupling to a first waste receptacle and a hook portion for coupling to a second waste receptacle.

### BACKGROUND

The collection of garbage (e.g., removal and transport) is basis among in any modern society with a considerable population density. Public sanitation, health, and even aesthetics are greatly improved with consistent garbage collection. In many residential areas, a local municipality employs a staff of public or private servicemen to routinely provide garbage collection services to municipality residents.

Many residential garbage collection service arrangements provide each residence receiving garbage collection service with pre-supplied waste receptacles. These pre-supplied waste receptacles commonly consist of one or more garbage carts for each household. For example, a cart for disposing recyclables and a separate cart for disposing non-recyclables are common.

According to typical service arrangements, each residence receiving garbage collection service is required to physically deliver the waste receptacles to appropriate locations (e.g., proximate to a street curb) by the designated date and time, whereupon the garbage is collected. According to common practice, the waste receptacles are then relocated after garbage collection from the designated area to a customary position for receiving garbage (typically with greater proximity to the residence, and removed from view from the street).

The pre-supplied waste receptacles generally come in standard sizes, such as 32 or 64 gallons of volume for instance, are usually wheeled, and may include a plurality of handles for easier transport. However, due to the size and weight of each cart (particularly when filled with refuse), it is generally difficult to move more than one cart at a time. A resident is thus often required to repeat a procedure to physically transport each waste receptacle one at a time from its customary position for receiving garbage to the area designated for garbage collection. This process is then repeated for returning the empty receptacles one at a time from the collection area to the storage area.

Accordingly, this procedure is inefficient and time consuming, particularly if the distance between the customary position for receiving garbage to the area designated for garbage collection is significant.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

What is needed is a device to connect two or more carts to allow the customer to transport the carts with greater efficiency. The embodiments of the invention take advantage of the fact that many carts are provided of standard size and shape because mechanical lift mechanisms are used to collect the trash and recyclables. These standard shapes typically include a handle or handles to move the carts and a mid located bar on which mechanical lift mechanisms can be placed to secure the cart when being emptied. Standard carts also typically include a set of wheels which are used for cart transportation when the cart is tipped at an angle (e.g. handle down). The device is adapted for securing to a handle of one cart and the mid located bar of another cart for ready transport of a pair of carts

Embodiments of the present invention are directed to a device used in transporting a plurality of waste receptacles. Specifically, a device for coupling a plurality of waste receptacles to allow an efficient transport thereof is provided. Embodiments also address a method for coupling a plurality of waste receptacles with a device for coupling a plurality of waste receptacles, and a system of a plurality of coupled waste receptacles.

In one embodiment, a device is provided for coupling a plurality of waste receptacles to allow efficient transport thereof. The device is provided with a plurality of securing ends designed to temporarily couple with a surface or object of each of two waste receptacles. Once the device is coupled to both waste receptacles, the “train” of waste receptacles may be transported together. In one embodiment, the device is designed to couple to a handle of one cart and a mid-located bar of another cart. In this configuration, when one cart is lifted such that its wheels are free (e.g., off the ground), the cart is totally lifted off the ground, providing easy movement thereof.

Other embodiments provide a method for coupling a plurality of waste receptacles with a device for coupling a plurality of waste receptacles. According to the method, a securing end of the device is affixed to a surface or object of a first waste receptacle. An alternate (unoccupied) securing end of the same device is then affixed to a surface or object of a second waste receptacle. Common objects used to secure the waste receptacles include handles and/or rims. Waste receptacles with one or more handles positioned on an anterior surface may also be coupled to form a cascade of linked receptacles.

### BRIEF DESCRIPTION OF DRAWINGS

The accompanying drawings, which are incorporated in and form a part of this specification, illustrate embodiments of the invention and, together with the description, serve to explain the principles of the invention:

FIG. 1 is an illustration of a side-view layout of an exemplary device for coupling two or more waste receptacles, in accordance with one embodiment.

FIG. 2A is an illustration of a top-view layout of an exemplary device for coupling two or more waste receptacles, in accordance with one embodiment.

FIG. 2B is an illustration of a bottom-view layout of an exemplary device for coupling two or more waste receptacles, in accordance with one embodiment.

FIG. 3A is an illustration of an end-view layout from a hook portion orientation of an exemplary device for coupling two or more waste receptacles, in accordance with one embodiment.

FIG. 3B is an illustration of an end-view layout from a latch portion orientation of an exemplary device for coupling two or more waste receptacles, in accordance with one embodiment

FIG. 4 is a three dimensional illustration of a side-view layout of an exemplary device for coupling two or more waste receptacles, in accordance with one embodiment.

FIG. 5A is a three dimensional illustration of a side-view layout of an exemplary device with a hinged hook portion for coupling two or more waste receptacles, in accordance with one embodiment.

FIG. 5B is an illustration of a three dimensional side-view layout of an exemplary device with a transfigured hinged hook portion for coupling two or more waste receptacles, in accordance with one embodiment.

FIG. 6A is a three dimensional illustration of a side-view layout of an exemplary device with a hinged latch portion for coupling two or more waste receptacles, in accordance with one embodiment.

FIG. 6B is an illustration of a three dimensional side-view layout of an exemplary device with a transfigured hinged latch portion for coupling two or more waste receptacles, in accordance with one embodiment.

FIG. 7A is an illustration of a posterior-view of an exemplary waste receptacle in accordance with one embodiment.

FIG. 7B is an illustration of a posterior-view of an exemplary waste receptacle coupled to a latch portion of an exemplary device for coupling two or more waste receptacles in accordance with one embodiment.

FIG. 7C is an illustration of a posterior-view of an exemplary waste receptacle coupled to a hook portion of an exemplary device for coupling two or more waste receptacles in accordance with one embodiment.

FIG. 8A is an illustration of an anterior-view of an exemplary waste receptacle in accordance with one embodiment.

FIG. 8B is an illustration of an anterior-view of an exemplary waste receptacle coupled to a latch portion of an exemplary device for coupling two or more waste receptacles in accordance with one embodiment.

FIG. 8C is an illustration of an anterior-view of an exemplary waste receptacle coupled to a hook portion of an exemplary device for coupling two or more waste receptacles in accordance with one embodiment.

FIG. 9A is an illustration of a side-view layout of an exemplary waste receptacle with a posterior handle coupled to the hook portion of an exemplary device for coupling two or more waste receptacles in accordance with one embodiment.

FIG. 9B is an illustration of a side-view layout of an exemplary waste receptacle with an anterior handle coupled to the latch portion of an exemplary device for coupling two or more waste receptacles in accordance with one embodiment.

FIG. 10A is an illustration of a side-view layout of an exemplary waste receptacle with a posterior handle coupled to the latch portion of an exemplary device for coupling two or more waste receptacles in accordance with one embodiment.

FIG. 10B is an illustration of a side-view layout of an exemplary waste receptacle with an anterior handle coupled to the hook portion of an exemplary device for coupling two or more waste receptacles in accordance with one embodiment.

FIG. 11 is an illustration of a side-view layout of two exemplary waste receptacles coupled by an exemplary device for coupling two or more waste receptacles, in accordance with one embodiment.

FIG. 12 is an illustration of a side-view layout of two exemplary waste receptacles coupled by an exemplary device for coupling two or more waste receptacles, wherein a waste receptacle is leveraged off the ground, in accordance with one embodiment.

FIG. 13 is an illustration of a side-view layout of three exemplary waste receptacles coupled by two exemplary devices for coupling two or more waste receptacles, in accordance with one embodiment.

FIG. 14 depicts a flowchart of a method for coupling two or more waste receptacles, in accordance with one embodiment.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, and components, have not been described in detail as not to unnecessarily obscure aspects and features of the subject matter.

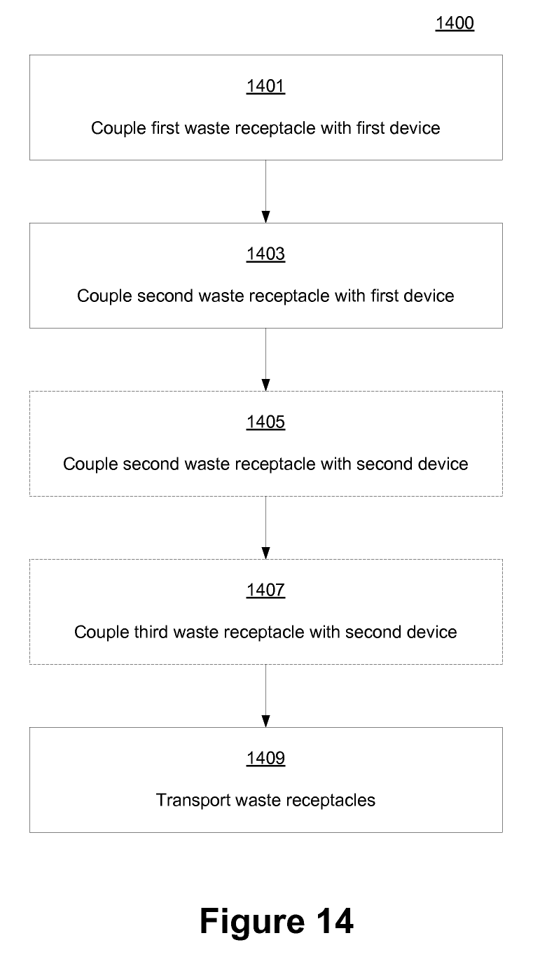

Portions of the detailed description that follows are presented and discussed in terms of a method. Although steps and sequencing thereof are disclosed in a figure herein (e.g., FIG. 14) describing the operations of this method, such steps and sequencing are exemplary. Embodiments are well suited to performing various other steps or variations of the steps recited in the flowchart of the figure herein, and in a sequence other than that depicted and described herein.

In the following embodiments, an approach is described for a plurality of waste receptacles to allow an efficient transport thereof. Embodiments include a device for coupling at least two carts for easy transport thereof. Embodiments also propose a method and system for coupling a plurality of waste receptacles via a device for coupling two or more waste receptacles.

### Device for Coupling Two Waste Receptacles

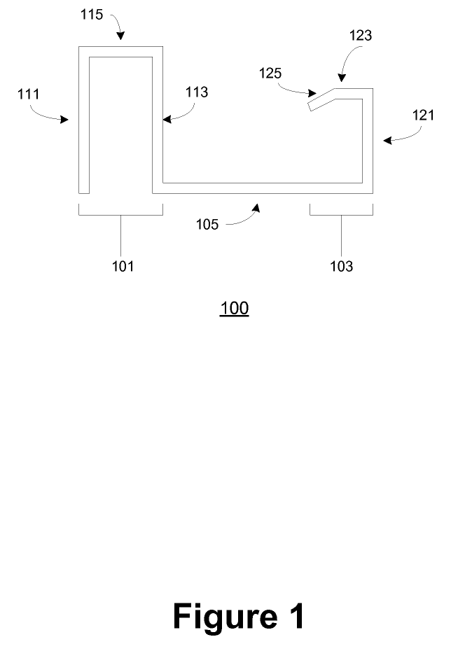

With reference now to FIG. 1, an illustration of a side-view layout of exemplary device 100 for coupling two or more waste receptacles is depicted, in accordance with one embodiment. In a typical configuration, device 100 includes two or more securing portions (e.g., hook portion 101 and latch portion 103) separated by a bar of rigid material 103.

Device 100 may be scored from a length of sheet metal or other rigid material. In one embodiment, device 100 may be formed roughly in the shape of an “S,” with each end of device 100 comprising a portion structurally shaped to affix to a waste receptacle. For example, one end of device 100 may be shaped to form a hook (e.g., hook portion 101), and another end shaped to form a latch (e.g., latch portion 103).

Hook portion 101 may be formed to include two roughly equivalent lengths of rigid material (e.g., sides 111 and 113) positioned in parallel and coupled by a perpendicular “bridge” of another length of rigid material (e.g., bridge 115), arranged to form an inverted “U.” In alternate embodiments, hook portion 101 may be formed from a curved length of rigid material according to a traditional hook structure. Latch portion may be formed to include a length of rigid material (e.g. side 121) perpendicularly coupled to a protruding length of rigid material (e.g., protruding surface 123), wherein a portion (e.g., slanted surface 125) of the protruding length is slanted so as to prevent a secured structure (e.g., a latched handle or waste receptacle rim) from becoming detached during transport.

In a further embodiment, hook portion 101 and latch portion 103 may be coupled via bar of rigid material 103. In alternate embodiments, device 100 may have both ends shaped to form hooks, or alternatively shaped to form latches. In still further embodiments, device 100 may comprise more than two ends and/or portions shaped to affix to a waste receptacle.

Device 100 is coupled to a first waste receptacle via one end (e.g., either hook portion 101 or latch portion 103). A second waste receptacle is coupled to an unoccupied end of device 100 (e.g., an end portion of device 100 that was not coupled to the handle of the first waste receptacle). In a preferred embodiment, a handle on the anterior surface of the first waste receptacle is coupled to a handle or bar on the posterior surface of the second waste receptacle, so as to establish a common orientation among both waste receptacles and subsequently creating a “train” of linked waste receptacles.

Device 100 may also be reversibly coupled to the waste receptacles. For example, a configuration wherein a first waste receptacle is coupled to the latch portion 103 of device 100 and a second waste receptacle is coupled to the hook portion 101 of device 100 may be alternatively configured such that the first waste receptacle may be coupled to the hook portion 101 of device 100 and the second waste receptacle may be coupled to the latch portion 103 of device 100.

Contemporary waste receptacles commonly include one or more handles positioned at or near the rim of the waste receptacle on the posterior of the waste receptacle (“posterior handle”), and one or more handles positioned towards the center of an anterior surface of the waste receptacle (“anterior handle”), or mid located bar. According to these embodiments, a securing end of device 100 may be attached to the anterior handle of a first waste receptacle, with an alternate securing end of device 100 affixed to a posterior handle of a second waste receptacle, so as to form a cascade of linked waste receptacles, wherein the height of each waste receptacle, when coupled, is non-uniform. In this fashion, the cart connected via its anterior handle may be tipped so that the other cart is lifted completely off the ground.

A third waste receptacle may be appended to the cascade of linked waste receptacles by attaching a securing end of a second device to an anterior handle of the second waste receptacle, and an alternate securing end of the second device to a posterior handle of a third waste receptacle. Additional waste receptacles may be appended in a like manner.

Device 100 may not be limited to coupling with waste receptacle handles. For example, either (or both) hook portion 101 or latch portion 103 may be affixed to one or more waste receptacles by hooking (or latching) other objects or surfaces (e.g., a rim) of a waste receptacle. Once device 100 has been secured to two waste receptacles, the train (or cascade) of linked waste receptacles may be transported (e.g., towed) by dragging the waste receptacle at the “front” of the train (or cascade).

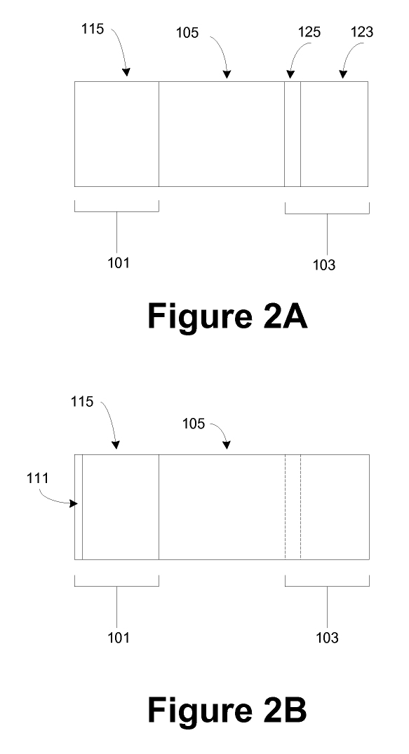

With reference now to FIG. 2A, an illustration of a top-view layout of exemplary device 100 for coupling two or more waste receptacles is depicted, in accordance with one embodiment. As depicted, a top-view layout of exemplary device 100 includes the securing ends (e.g., hook portion 101 and latch portion 103), and a connecting portion (e.g., bar of rigid material 105). A top-view layout of hook portion 101 includes bridge 115. A top-view layout of latch portion 103 may include protruding surface 123 and slanted surface 125.

FIG. 2B is an illustration of a bottom-view layout of exemplary device 100 for coupling two or more waste receptacles, in accordance with one embodiment. As depicted, a bottom-view layout of exemplary device 100 includes the securing ends (e.g., hook portion 101 and latch portion 103), and a connecting portion (e.g., bar of rigid material 105). A bottom-view layout of hook portion 101 includes the bottom surface of side 111. Dashed lines representing the position of protruding surface 123 and slanted surface 125 have been provided, but the actual referenced surfaces may not be visible in a bottom-view layout of exemplary device 100.

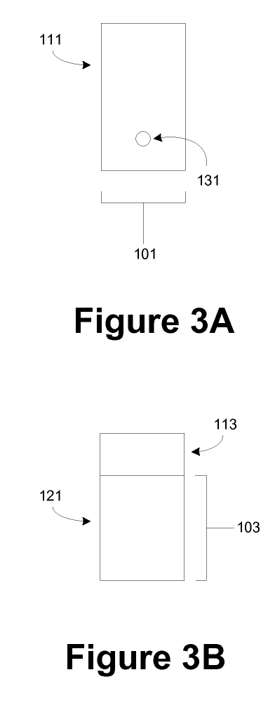

With reference now to FIG. 3A, an illustration of an end-view layout from a hook portion orientation of exemplary device 100 for coupling two or more waste receptacles is depicted, in accordance with one embodiment. As depicted, a side-view layout from a hook portion orientation of exemplary device 100 displays side surface 111, one of the two parallel surfaces comprising hook portion 101. According to one embodiment, device 100 may include optional aperture 131. In one embodiment, aperture 131 may be positioned on side 111, so as to allow pensile storage of device 100. For example, device 100 may be hung from a protruding object (e.g., a nail) through aperture 131 when device 100 is not in active use.

FIG. 3B is an illustration of an a side-view layout from a latch portion orientation of exemplary device 100 for coupling two or more waste receptacles is depicted, in accordance with one embodiment. As depicted, an end-view layout from a latch portion orientation of exemplary device 100 displays side 121 of latch portion 103. According to some embodiments, the lengths of the sides comprising hook portion 101 (e.g., side 111 and 113) are greater than the length of the side comprising latch portion 103 (e.g., side 121). In such embodiments, an end-view layout from a latch portion orientation of device 100 may include a portion of side 113 of hook portion 101.

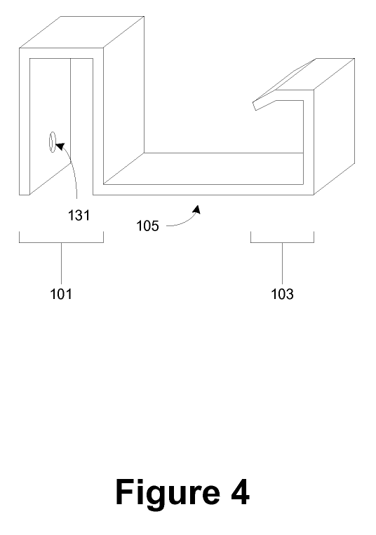

With reference now to FIG. 4, a three dimensional illustration of a side-view layout of exemplary device 100 for coupling two or more waste receptacles is depicted, in accordance with one embodiment. In a typical configuration, device 100 includes two or more securing portions (e.g., hook portion 101 and latch portion 103) separated by a bar of rigid material 103, and aperture 131 located in hook portion 101. Each of the elements has been described in detail above.

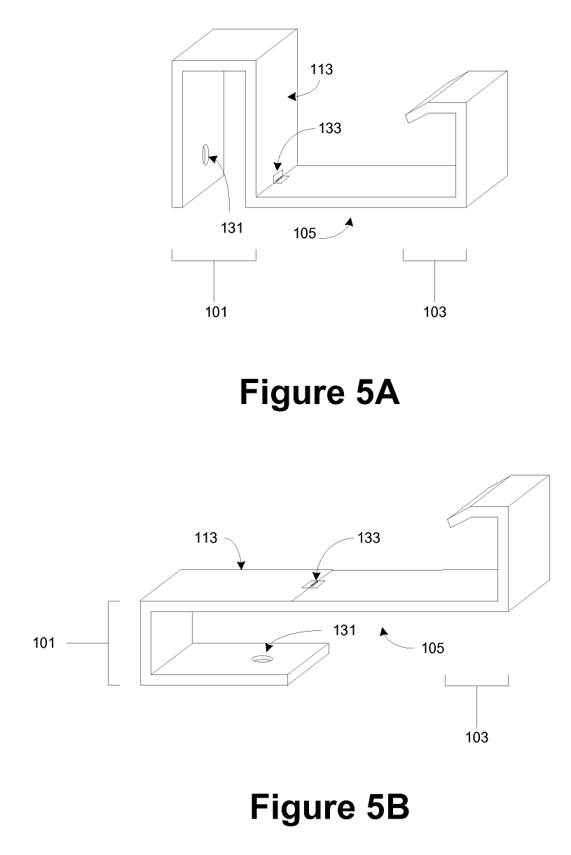

With reference now to FIG. 5A, a three dimensional illustration of a side-view layout of exemplary device 100 with a hinged hook portion for coupling two or more waste receptacles is depicted, in accordance with one embodiment. In a typical configuration, device 100 includes two or more securing portions (e.g., hook portion 101 and latch portion 103) separated by a bar of rigid material 103, and aperture 131 located in hook portion 101. Each of the elements has been described in detail above.

According to one embodiment, one or more securing ends of device 100 may be hinged to allow transfiguring hook portion 101 along an axis of rotation (centered around hinge 133). Transfiguring hook portion 101 along an axis of rotation may be used, for example, to allow device 100 to couple with larger and/or non-conforming structures. In one embodiment, hook portion 101 of device 100 is coupled to bar of rigid material 103 via hinge 133 coupled to side 113 of hook portion 101. As depicted, hinge 133 is positioned along an upper surface of bar of rigid material 105 and a surface of side 113 adjacent to an upper surface of bar of rigid material 105. In alternate embodiments, hinge 133 may be positioned along a lower surface of bar of rigid material 105 and a surface of side 113 adjacent to a lower surface of bar of rigid material 105.

FIG. 5B is an illustration of a three dimensional side-view layout of exemplary device 100 with a transfigured hinged hook portion for coupling two or more waste receptacles, in accordance with one embodiment. As depicted, hook portion 101 is transfigured along an axis of rotation, with hinge 133 as the center of rotation. As presented, hook portion 101 has been transfigured so that side 113 is parallel with bar of rigid material 105; accordingly, alternate angles of transfiguration are possible.

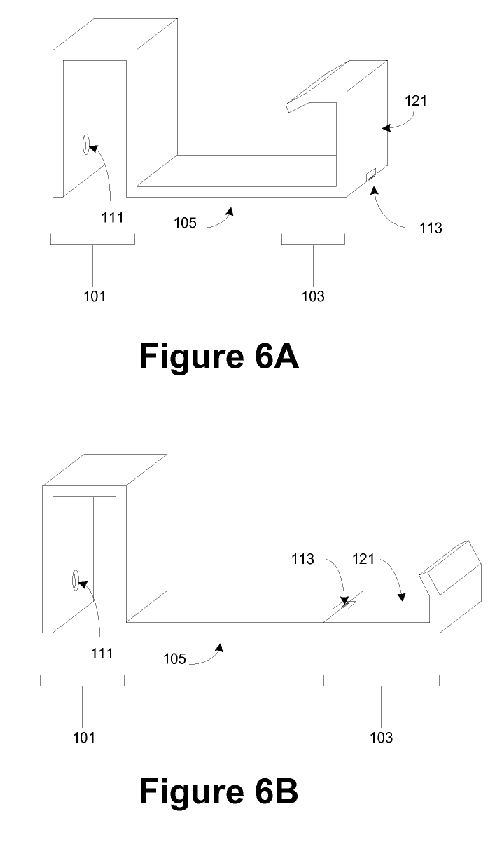

With reference now to FIG. 6A, a three dimensional illustration of a side-view layout of exemplary device 100 with a hinged latch portion for coupling two or more waste receptacles is depicted, in accordance with one embodiment. In a typical configuration, device 100 includes two or more securing portions (e.g., hook portion 101 and latch portion 103) separated by a bar of rigid material 103, and aperture 131 located in hook portion 101. Each of the elements has been described in detail previously.

In one embodiment, latch portion 103 of device 100 is coupled to bar of rigid material 103 via hinge 133 coupled to side 121 of latch portion 103. As depicted, hinge 133 is positioned along an lower surface of bar of rigid material 105 and a surface of side 121 adjacent to an lower surface of bar of rigid material 105.

FIG. 6B is an illustration of a three dimensional side-view layout of exemplary device 100 with a transfigured hinged latch portion for coupling two or more waste receptacles, in accordance with one embodiment. As depicted, hinge 133 is positioned along an upper surface of bar of rigid material 105 and a surface of side 121 adjacent to an upper surface of bar of rigid material 105. As presented, latch portion 103 has been transfigured so that side 113 is parallel with bar of rigid material 105; accordingly, alternate angles of transfiguration are possible.

### Exemplary Waste Receptacle

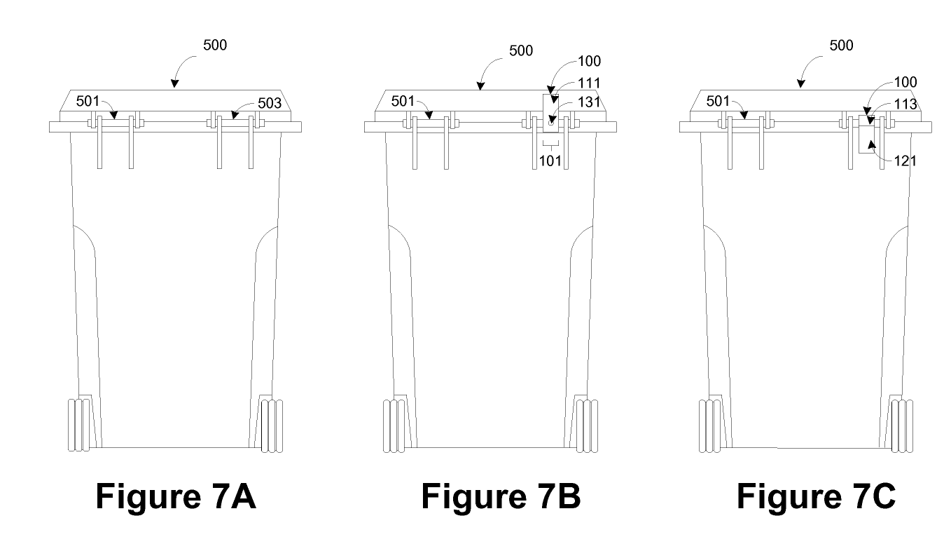

With reference now to FIG. 7A, an illustration of a posterior-view layout of an exemplary waste receptacle 500 is depicted, in accordance with one embodiment. In a typical configuration, waste receptacle 500 includes one or more handles near the rim of the container (e.g. handles 501 and 503) positioned on a posterior surface of waste receptacle 500. For example, handle 501 and/or 503 may be positioned towards the zenith of a posterior surface of waste receptacle 500. In further embodiments, handle 501 and/or 503 may be conjoined (forming a larger handle). As depicted, handle 501 and handle 503 are displaced and positioned in parallel.

FIG. 7B is an illustration of a posterior-view layout of an exemplary waste receptacle 500 coupled to a latch portion of device 100 for coupling two or more waste receptacles in accordance with one embodiment. As depicted, handle 503 of waste receptacle 500 is coupled to latch portion 103 of device 100. As presented, the view of latch portion 103 has been fully obscured by side 111 of hook portion 101 and aperture 131 of device 100.

FIG. 7C is an illustration of a posterior-view layout of an exemplary waste receptacle 500 coupled to a hook portion of device 100 for coupling two or more waste receptacles in accordance with one embodiment. As depicted, handle 503 of waste receptacle 500 is coupled to hook portion 101 of device 100. As presented, the view of hook portion 101 has been partially obscured by side 121 of latch portion 103. Accordingly, only a portion of side 113 is visible, as displayed.

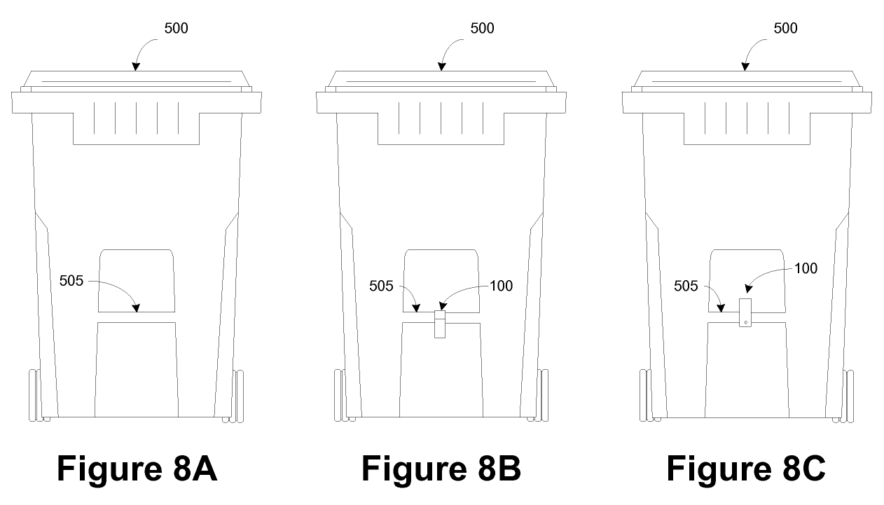

With reference now to FIG. 8A, an illustration of an anterior-view layout of an exemplary waste receptacle 500 is depicted, in accordance with one embodiment. In a typical configuration, waste receptacle 500 includes one or more mid-located handles (e.g. handle 505) or bars positioned on an anterior surface of waste receptacle 500. In some embodiments, mid-located handle 505 may be positioned proximate to the center of an anterior surface of waste receptacle 500.

FIG. 8B is an illustration of a anterior-view layout of an exemplary waste receptacle 500 coupled to a latch portion of device 100 for coupling two or more waste receptacles in accordance with one embodiment. As depicted, handle 503 of waste receptacle 500 is coupled to hook portion 101 of device 100. As presented, the view of hook portion 101 has been partially obscured by side 121 of latch portion 103. Accordingly, only a portion of side 113 is visible, as displayed.

FIG. 8C is an illustration of a anterior-view layout of an exemplary waste receptacle 500 coupled to a latch portion of device 100 for coupling two or more waste receptacles in accordance with one embodiment. As depicted, handle 505 of waste receptacle 500 is coupled to latch portion 103 of device 100. As presented, the view of latch portion 103 has been fully obscured by side 111 of hook portion 101 and aperture 131 of device 100.

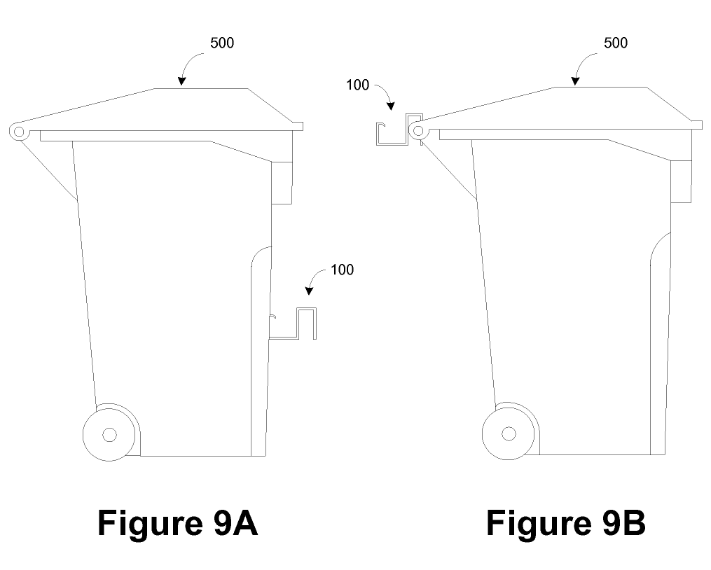

With reference now to FIG. 9A, an illustration of a side-view layout of exemplary waste receptacle 500 with an anterior handle coupled to a latch portion of exemplary device 100 for coupling two or more waste receptacles is depicted, in accordance with one embodiment. As depicted, the anterior handle of waste receptacle 500 coupled to the latch portion of device 100 is positioned proximate to the center of an anterior surface of waste receptacle 500. As presented, the hook portion of device 100 is unsecured (e.g., not coupled to a surface or object). Accordingly, the hook portion of device 100 may be used to couple to the handle of another waste receptacle (e.g., according to FIG. 9B).

FIG. 9B is an illustration of a side-view layout of an exemplary waste receptacle 500 with a posterior handle coupled to a hook portion of exemplary device 100 for coupling two or more waste receptacles in accordance with one embodiment. As depicted, the posterior handle of waste receptacle 500 coupled to the hook portion of device 100 is positioned towards the zenith of a posterior surface of waste receptacle 500. As presented, the latch portion of device 100 is unsecured (e.g., not coupled to a surface or object). Accordingly, the latch portion of device 100 may be used to couple to the handle of another waste receptacle (e.g., according to FIG. 9A).

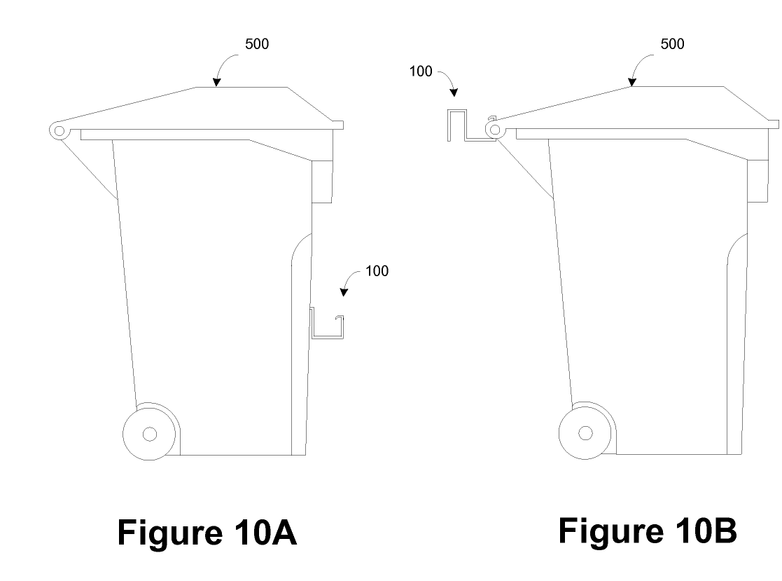

With reference now to FIG. 10A, an illustration of a side-view layout of exemplary waste receptacle 500 with an anterior handle coupled to a hook portion of exemplary device 100 for coupling two or more waste receptacles is depicted, in accordance with one embodiment. As depicted, the anterior handle of waste receptacle 500 coupled to the hook portion of device 100 is positioned proximate to the center of an anterior surface of waste receptacle 500. As presented, the latch portion of device 100 is unsecured (e.g., not coupled to a surface or object). Accordingly, the latch portion of device 100 may be used to couple to the handle of another waste receptacle (e.g., according to FIG. 10B).

FIG. 10B is an illustration of a side-view layout of an exemplary waste receptacle 500 with a posterior handle coupled to a latch portion of exemplary device 100 for coupling two or more waste receptacles in accordance with one embodiment. As depicted, the posterior handle of waste receptacle 500 coupled to the hook portion of device 100 is positioned towards the zenith of a posterior surface of waste receptacle 500. As presented, the latch portion of device 100 is unsecured (e.g., not coupled to a surface or object). Accordingly, the hook portion of device 100 may be used to couple to the handle of another waste receptacle (e.g., according to FIG. 10A).

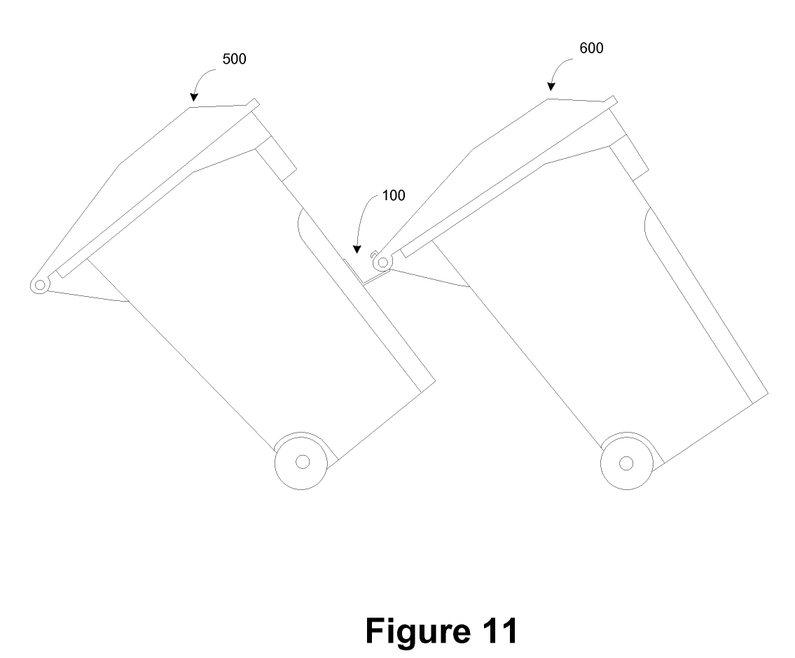

With reference now to FIG. 11, an illustration of a side-view layout of two exemplary waste receptacles (e.g., waste receptacles 500 and 600) coupled by an exemplary device (e.g. device 100) for coupling two or more waste receptacles is depicted, in accordance with one embodiment. As depicted, waste receptacle 500 is coupled to waste receptacle 600 via device 100. An anterior handle of waste receptacle 500 is coupled to a hook portion of device 100, and a posterior handle of waste receptacle 600 is coupled to a latch portion of device 100. As presented, waste receptacle 500 and waste receptacle 600, coupled via device 100, comprise a train of linked waste receptacles which can be transported together via normal transportation procedures directed towards waste receptacle 500 (e.g., dragging waste receptacle 500 via posterior handles).

In alternate configurations, alternate securing ends may be used. For example, the anterior handle of waste receptacle 500 may be coupled to a latch portion of device 100, with the posterior handle of waste receptacle 600 coupled to the hook portion of device 100. In alternate embodiments, both handles may be coupled by a plurality of latch portions, or a plurality of hook portions.

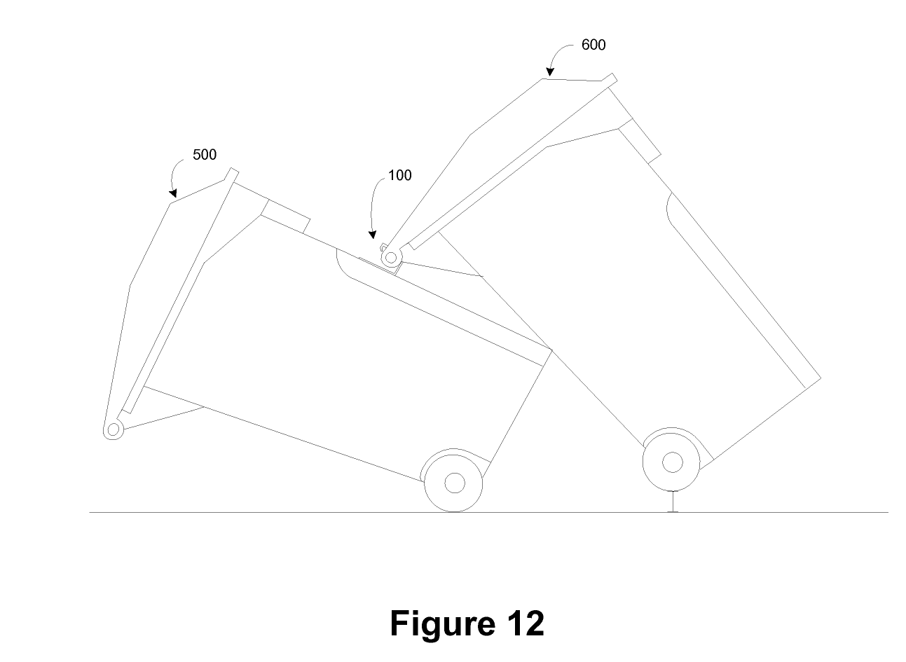

With reference now to FIG. 12, an illustration of a side-view layout of two exemplary waste receptacles (e.g., waste receptacles 500 and 600) coupled by an exemplary device (e.g. device 100) for coupling two or more waste receptacles, wherein a waste receptacle is leveraged off the ground to provide easier transport thereof is depicted, in accordance with one embodiment. As depicted, waste receptacle 500 is coupled to waste receptacle 600 via device 100. An anterior handle of waste receptacle 500 is coupled to a hook portion of device 100, and a posterior handle of waste receptacle 600 is coupled to a latch portion of device 100. As presented, waste receptacle 500 and waste receptacle 600, coupled via device 100, comprise a train of linked waste receptacles which can be transported together via normal transportation procedures directed towards waste receptacle 500 (e.g., dragging waste receptacle 500 via posterior handles).

As coupled, waste receptacle 600 is leveraged by waste receptacle 500 such that waste receptacle 600 is no longer in contact with the ground. Accordingly, transport of the waste receptacles within this configuration may be performed by dragging waste receptacle 500 (upon which waste receptacle 600 rests).

In alternate configurations, alternate securing ends may be used. For example, the anterior handle of waste receptacle 500 may be coupled to a latch portion of device 100, with the posterior handle of waste receptacle 600 coupled to the hook portion of device 100. In alternate embodiments, both handles may be coupled by a plurality of latch portions, or a plurality of hook portions.

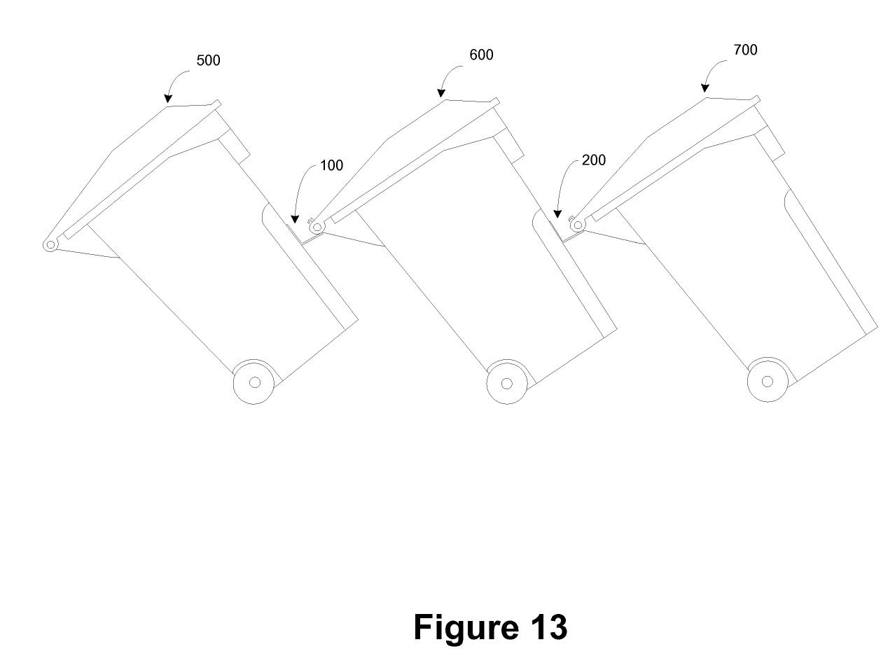

With reference now to FIG. 13, an illustration of a side-view layout of three exemplary waste receptacles (e.g., waste receptacles 500, 600 and 700) coupled by two exemplary devices (e.g., devices 100 and 200) for coupling two or more waste receptacles is depicted, in accordance with one embodiment. As depicted, waste receptacle 500 is coupled to waste receptacle 600 via device 100, and waste receptacle 600 is coupled to waste receptacle 700 via device 200. An anterior handle of waste receptacle 500 is coupled to a hook portion of device 100, and a posterior handle of waste receptacle 600 is coupled to a latch portion of device 100. A previously unsecured anterior handle of waste receptacle 600 is coupled to a hook portion of device 200, and a posterior handle of waste receptacle 700 is coupled to a latch portion of device 200. As presented, waste receptacle 500, waste receptacle 600, and waste receptacle 700, coupled via device 100 and device 200, comprise a train of linked waste receptacles which can be transported together via normal transportation procedures directed towards waste receptacle 500 (e.g., dragging waste receptacle 500 via posterior handles).

In alternate configurations, alternate securing ends may be used. For example, the anterior handle of waste receptacle 500 may be coupled to a latch portion of device 100, with the posterior handle of waste receptacle 600 coupled to the hook portion of device 100. Similarly. the anterior handle of waste receptacle 600 may also (but not necessarily) be coupled to a latch portion of device 200, with the posterior handle of waste receptacle 700 coupled to the hook portion of device 200. In alternate embodiments, any combination of the handles may be coupled by a plurality of latch portions, or a plurality of hook portions.

### Transporting a Plurality of Waste Receptacles

With reference now to FIG. 14, a flowchart 1400 of a method for transporting a plurality of waste receptacles is depicted, in accordance with one embodiment. Steps 1401-1409 describe exemplary steps comprising the process 1400 in accordance with the various embodiments herein described.

At step 1401, a first waste receptacle is coupled to a first device for coupling two waste receptacles. In some embodiments, the first device for coupling two waste receptacles includes a plurality of securing ends (e.g., a latch portion and/or a hook portion). Accordingly, the first waste receptacle may be coupled to the first device by affixing a securing end of the first device to a surface or object of the first waste receptacle (e.g., a handle, or rim of first waste receptacle). In some embodiments, the first device is coupled to the first waste receptacle via a handle positioned on an anterior surface of the first waste receptacle.

At step 1403, a second waste receptacle is coupled to the first device for coupling two waste receptacles. The second waste receptacle may be coupled to the first device by affixing a “free” securing end (e.g., a securing end not already affixed to a surface or object of the first waste receptacle) of the first device to a surface or object of the second waste receptacle. For example, an exemplary device with one latch portion and one hook portion may be coupled to the first waste receptacle via the latch portion of said device, and coupled to the second waste receptacle via the hook portion (or vice versa). In some embodiments, the first device is coupled to the second waste receptacle via a handle positioned on a posterior surface of the second waste receptacle.

By coupling a posterior handle of a second waste receptacle with a device already coupled to an anterior handle of a first waste receptacle, a cascade of linked waste receptacles may be formed. Additional waste receptacles may be appended to the cascade of linked waste receptacles.

At optional step 1405, an unsecured surface or object of the second waste receptacle is coupled to a second device for coupling two waste receptacles. In some embodiments, the second device for coupling two waste receptacles includes a plurality of securing ends (e.g., a latch portion and/or a hook portion). Accordingly, the second waste receptacle may be coupled to the second device by affixing a securing end of the second device to an unsecured surface or object of the second waste receptacle (e.g., a handle, or rim of first waste receptacle). For example, a second waste receptacle with a posterior handle affixed to a first device may be coupled to the second device via an anterior handle.

At optional step 1407, a third waste receptacle is coupled to the second device for coupling two waste receptacles. The third waste receptacle may be coupled to the second device by affixing a “free” securing end (e.g., a securing end not already affixed to a surface or object of the second waste receptacle) of the second device to a surface or object of the third waste receptacle. For example, an exemplary second device with one latch portion and one hook portion may be coupled to the second waste receptacle via the latch portion of said second device, and coupled to the third waste receptacle via the hook portion (or vice versa). In some embodiments, the second device is coupled to the third waste receptacle via a handle positioned on a posterior surface of the third waste receptacle.

At step 1409, the entire cascade of linked waste receptacles may be transported. Transporting a cascade of linked waste receptacles may, for example, comprise dragging the cascade of linked waste receptacles to a designated location. As the waste receptacles comprising the cascade of linked waste receptacles are coupled by the one or more devices for coupling waste receptacles, the entire cascade of linked waste receptacles may be transported efficiently with one procedure. In some configurations, the cascade of linked waste receptacles may be transported by normal transporting procedure directed at the first waste receptacle.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device for coupling waste receptacles for transport thereof, the device comprising:
a latch portion at one end for coupling to a first waste receptacle having wheels on one side; and
a hook portion at an opposite end for coupling to a second waste receptacle.

2. The device of claim 1, further comprising an aperture for allowing pensile storage of said device.

3. The device of claim 2, wherein said aperture is located on said hook portion.

4. The device of claim 1, wherein said latch portion and said hook portion are configured so that when said first waste receptacle is tipped on said wheels, said second waste receptacle when coupled to said first waste receptacle via said latch and said hook is positioned off the ground.

5. The device of claim 1, further comprising a rigid bar connecting said latch portion and said hook portion.

6. The device of claim 5, wherein said latch portion is coupled to said rigid bar via a hinge.

7. The device of claim 5, wherein said hook portion is coupled to said rigid bar via a hinge.

8. The device of claim 1, wherein said hook portion and said latch portion are adapted to couple to a mid-located handle of said first waste receptacle.

9. The device of claim 8, wherein said hook portion and said latch portion are adapted to couple to a rim-located handle of said second waste receptacle.

10. The device of claim 9, wherein said rim located handle is disposed on a posterior side of said second waste receptacle.

11. The device of claim 10, wherein said first waste receptacle is coupled to said second waste receptacle by coupling one of said latch portion and said hook portion to a anterior side handle of said first waste receptacle and coupling the other of said latch portion and said hook portion to a posterior handle of said second waste receptacle.

12. A method for transporting a plurality of waste receptacles comprising:
coupling a first waste receptacle having wheels on one side with one of a latch portion and a hook portion of a first device for coupling a plurality of waste receptacles;
coupling a second waste receptacle to said first waste receptacle by coupling said second waste receptacle with the other of said latch portion and said hook portion of said first device not coupled to said first waste receptacle; and
transporting said first waste receptacle coupled with said second waste receptacle.

13. The method of claim 12, wherein said transporting a plurality of waste receptacles comprises tipping said first waste receptacle on its wheels and causing said second waste receptacle to become lifted off the ground.

14. The method of claim 12, wherein said coupling a second waste receptacle to said first waste receptacle comprises creating a linked cascade of waste receptacles, said linked cascade of waste receptacles including said first waste receptacle and said second waste receptacle.

15. The method of claim 13, wherein transporting a plurality of waste receptacles comprises transporting said linked cascade of waste receptacles.

16. The method of claim 13, wherein creating a linked cascade of waste receptacles further comprises adding a third waste receptacle to said linked cascade of waste receptacles.

17. The method of claim 12, wherein said coupling a first waste receptacle comprises coupling one of said hook portion and said latch portion to a handle of said first waste receptacle located in the middle of said first waste receptacle and wherein said coupling a second waste receptacle comprises coupling the other of said hook portion and said latch portion to a handle of said second waste receptacle located proximate to a rim of said second waste receptacle.

18. A system for transporting a plurality of waste receptacles, the system comprising:
a first waste receptacle having a first handle and wheels located on one side;
a second waste receptacle having a second handle; and
a first device for coupling two waste receptacles, and comprising a hook coupled to said first handle and a latch coupled to said second handle.

19. The system of claim 18, wherein said first device is operable to lift said second waste receptacle off the ground when said first waste receptacle is tipped onto said wheels.

20. The system of claim 18, wherein said first handle of said first waste receptacle is located towards an anterior surface of said first waste receptacle.

21. The system of claim 19, wherein said second handle is located towards a posterior surface of said second waste receptacle.

22. The system of claim 20, wherein said first handle is located proximate to a middle of said first waste receptacle.

23. The system of claim 21, wherein said second handle is located proximate to a rim of said second waste receptacle.
